(19) United States
(12) Patent Application Publication
(10) Pub. No.: US 2014/0297453 A1
(43) Pub. Date: Oct. 2, 2014

(54) SYSTEM AND METHOD FOR CREATING A RIFF GIFT

(71) Applicant: Build A Song, Inc., Mission Viejo, CA (US)

(72) Inventor: DAVID PACK, Mission Viejo, CA (US)

(73) Assignee: Build A Song, Inc., Mission Viejo, CA (US)

(21) Appl. No.: 14/242,676

(22) Filed: Apr. 1, 2014

Related U.S. Application Data
(60) Provisional application No. 61/807,687, filed on Apr. 2, 2013.

(51) Int. Cl. H04L 12/58; G06Q 30/06; G06F 3/0482

(52) U.S. Cl. CPC H04L 51/10; G06F 3/0482; G06Q 30/0603; G06Q 30/0621
USPC 705/26.5; 715/719

(57) ABSTRACT

A method for creating a riff gift for a recipient includes receiving a video riff from an artist. The method includes coding and embedding the video riff into a database. The method further includes choosing a selected video riff. Additionally, the method includes embedding the selected video riff into an e-card such that it is ready to be sent to the recipient.

### CROSS-REFERENCE TO RELATED APPLICATIONS

This application claims the benefit of and priority to U.S. Provisional Application 61/807,687, filed Apr. 2, 2013, and titled System and Method for Creating a Riff Gift, the entire contents of which are incorporated herein by reference.

### TECHNICAL FIELD

The present disclosure relates generally to digital media, and more particularly, some embodiments relate to creating a riff gift for E-greetings using digital media.

### DESCRIPTION OF THE RELATED ART

With the advent of the Internet, the distribution of digital media has become popular. In this regard, E-greeting cards may be used instead of conventional paper cards. To date, people have not created customized digital media to be used in E-greeting cards. Further, distribution of digital media has been facilitated in a number of ways such as via digital retail stores (e.g., Apple iTunes®) and online websites (e.g., Amazon.com). Generally, the same digital media is distributed across various distribution systems. For example, a song that is distributed on Apple iTunes® may also be found at Amazon.com; however, Apple iTunes® and Amazon.com may distribute the same song at different prices or in different file types (e.g., mp3, way, etc.) These digital media distribution systems are simply passive warehouses of digital media that consumers or artists cannot customize.

In an Internet driven world, where the value of a song (or instrumental music) has never been worth less, some artists are forced to give their songs away. The legendary Quincy Jones has even lamented that “I'm dedicating the rest of my life to saving the music industry.” A new business model is needed to represent ‘thinking differently” about the future of music and “imaging” new possibilities.

### BRIEF SUMMARY OF THE DISCLOSURE

In view of the above drawbacks, there exists a long-felt need for new avenues of media communication, including customizable song and video clips that can be sent as E-cards (or riff gifts), that create revenue-generating opportunities for recording artists. Consumers purchase an average of 10 greeting cards a year. A riff gift provides an attractive alternative for the social network and mobile community that is like nothing else that exists in the $7 billion e-gift marketplace. The riff gift model, as described herein, represents a radically new and simple way to create and send a highly personalized e-card, for any occasion or expression that features music in a revolutionary new way.

A riff gift musical E-greeting provides consumers the opportunity to send a short video “riff” featuring a favorite music star that is incorporated into the E-greeting. In some embodiments, the consumer can further personalize an e-card by adding photos or private mobile videos, the consumer's voice, and custom artwork. In further embodiments, the consumer can even choose a charity to make a donation in the name of a loved one. Creating a riff gift helps the consumer express feelings using words, music, and visual images. Additionally, creating a riff gift is a fun, game-like experience that can be completed in under five minutes, and instantly shared.

One embodiment of the present disclosure provides a non-transitory computer readable medium having computer executable program code embodied thereon. The computer executable program code is configured to cause a computing device to create a riff gift for a recipient by: receiving at least one video riff from a plurality of artists; coding and embedding the video riff into a database containing a menu of artists; presenting the user with a menu of video riffs for choosing a selected video riff; and embedding the selected video riff into an e-card such that the e-card is ready to be sent to the recipient.

In some embodiments, the video riff comprise a 30-second or one-minute riff that is sung, played, spoken, rapped, or free-formed by the artist. The video riff may be filmed using a mobile device or other video recording system, and then loaded into the database. The database is searchable based by the name of the artist, a selected occasion, and a selected expression. The operation of presenting the user with a menu of video riffs for choosing a selected video riff can comprise presenting the user with a list of artists for the user to select a particular artist, and then presenting one or more video riffs by that artist for sampling and selection by the user.

In some cases, customized digital media may be distributed with customized E-greetings, where royalties are paid to various parties such as owners of the original digital media, or artists or songwriters composing the video riffs with a set of alternative lyrics. In some embodiments, various royalty tables are created, wherein a payment is collected from a user and royalty payments are allocated according to an appropriate royalty table. In further embodiments, gifts may be sent together with the E-greeting.

Other features and aspects of the disclosure will become apparent from the following detailed description, taken in conjunction with the accompanying drawings, which illustrate, by way of example, the features in accordance with embodiments of the disclosure. The summary is not intended to limit the scope of the claims, which is defined solely by the claims themselves.

### BRIEF DESCRIPTION OF THE FIGURES

The present disclosure, in accordance with one or more various embodiments, is described in detail with reference to the following figures. The figures are provided for purposes of illustration only and merely depict example embodiments of the disclosure. These figures are provided to facilitate the reader's understanding of the disclosure and shall not be considered limiting of the breadth, scope, or applicability of the disclosure or the claims. It should be noted that for clarity and ease of illustration these figures are not necessarily made to scale.

FIG. 1 illustrates an example system for creating a riff gift for an E-greeting in accordance with one embodiment of the disclosure. This example is implemented in an environment that includes various user systems connected via a communication medium.

FIG. 2 is a flow diagram illustrating an example of a method for creating a riff gift according to an embodiment of the disclosure.

FIG. 3 is a flow chart illustrating an example of a method for creating and distributing customized digital media in accordance with an embodiment of the disclosure.

FIGS. 4-1 to 4-3 illustrate a system chart depicting an example of a system for creating a riff gift in accordance with an embodiment of the disclosure.

FIGS. 5-1 to 5-3 illustrate a system chart depicting an example system for creating a riff gift in accordance with an embodiment of the disclosure.

FIG. 6 illustrates an example computing module that may be used in implementing various features of embodiments of the disclosure.

The figures are not intended to be exhaustive or to limit the disclosure or claims to the precise form disclosed. It should be understood that the disclosure can be practiced with modification and alteration and includes equivalents thereof.

### DETAILED DESCRIPTION

Embodiments of the disclosure provide systems and methods for creating an e-card with a video riff. In particular, customized E-greetings with customized digital media may be created and distributed. In some cases, royalties are paid to various parties, such as owners of the original digital media and providers of various video riffs. In some embodiments, various royalty tables are created, wherein a payment is collected from a user and royalty payments are allocated according to an appropriate royalty table. In further embodiments, gifts are chosen and sent together with the E-greeting.

As used herein, a “riff gift” may include an e-card and/or gift featuring a user-selected video riff. In some embodiments, a method of creating a riff gift begins with a world-famous recording artist or writer creating and singing an exclusive riff gift song for a special occasion or expression. The artist may write and sing multiple sets of lyrics, and create multiple music styles (e.g., folk, rock, orchestral, etc.), and then upload tracks to be used in the riff gift.

A user may choose a particular riff gift by selecting an appropriate “occasion” and/or “artist” from a list of options, as well as making lyric selections. The options may be filled from a database. The user's selections are passed to a synchronization engine via a database query. The engine parses this request, fetches the necessary files, and compiles the riff gift in high-resolution audio. Compression is done to the desired output format, and the file is made accessible to the purchaser. In this manner, the user creates a riff gift that is personalized via the user's selections.

In some embodiments, the riff gift includes a 30-second or one-minute riff that is sung, played, spoken, rapped, or free-formed by a music or film star or artist. The riff can be recorded using a mobile device and uploaded such that a user can purchase the riff for a predetermined price as an E-card gift. The star or artist may send several mobile video riffs that the user can choose from to fit a desired occasion or expression.

In certain embodiments, the artist or star shares in the net revenue from each e-card with riff download. This sharing creates a new revenue stream for artists and songwriters that does not currently exist, as well as a novel gift card for consumers. Revenue streams may be broadened to include subscription models, advertising revenue, and strategic alliances with strategic partners.

The user, in further embodiments, can select, for example, a one-minute video riff by a favorite music star to be incorporated into the user's E-greeting. Various artists have recorded fun, cool, hot music riffs via a mobile phone video, and uploaded the riffs to a riff gift homepage or application for the artist's music fans/users to discover and use as appropriate for a particular occasion. Using video riffs recorded on mobile phone video also allows instrumental music stars and artists to participate along with film and television actors and comedians. Additional embodiments of the disclosure provide users with the option to select a secret gift box feature where the user can choose from a variety of retail items, including wine, chocolate, flowers, jewelry, clothing, travel, etc.

In contrast to traditional cards that are usually discarded, a riff gift e-card can be conveniently stored digitally for as long as the user likes. In some embodiments, the e-card can be stored in the cloud via a personal riff gift library, and then re-called, refreshed, and re-purposed as desired. Additionally, sharing e-card variations with the user's social network can create more buzz, interest, and traffic that can convert to additional sales of riffs.

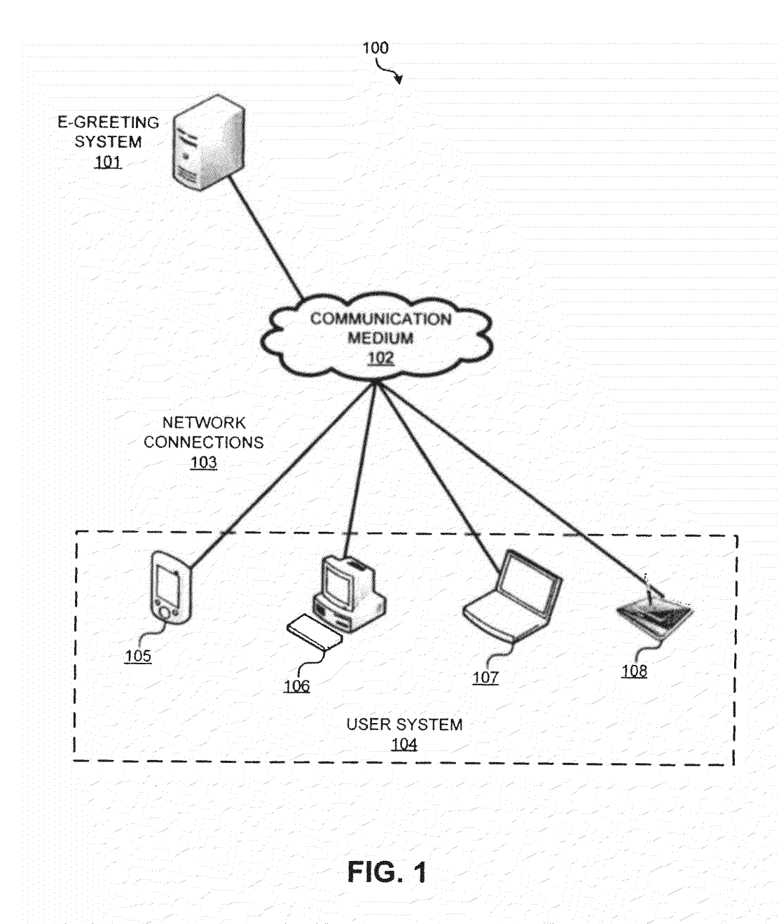

Before describing the disclosure in further detail, example environments for implementing various embodiments of the present disclosure will be described. FIG. 1 illustrates one such example.

FIG. 1 illustrates example system 101 for creating an e-greeting with video riffs in accordance with one embodiment of the disclosure. In this example, system 101 is implemented in environment 100, which includes various user systems 104 connected via communication medium 102. Communication medium 102 may include a wired system, such as a coaxial cable system, a fiber optic cable system, an Ethernet cable system, or other similar communication medium system. Additionally, communication medium 102 may include a wireless network system, such as a wireless personal area network, a wireless local area network, a cellular network, or other similar communication medium.

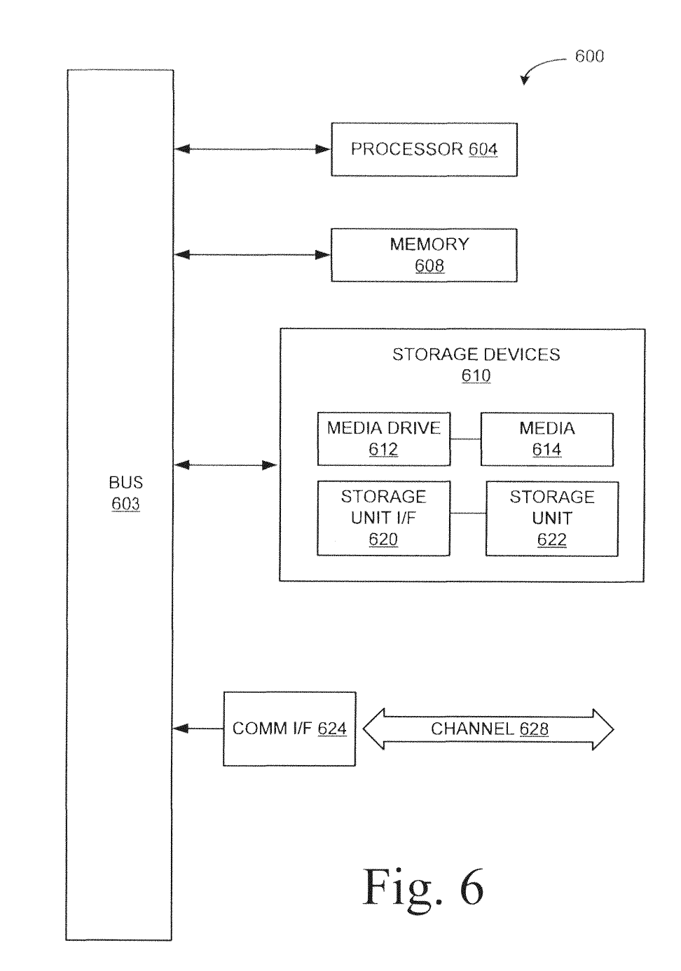

As shown, user systems 104 may include devices such as smartphone 105 (e.g., an iPhone®), desktop computer 106, laptop computer 107, and/or tablet 108 (e.g., an iPad®). These devices, through their respective network connections 103, can either interact directly or indirectly with system 101 to create and share an E-greeting with video riff, or to distribute a digital media. Network connection 103 may include, for example, wired connections (e.g., Digital Subscriber Line (DSL), optical), and wireless connections (e.g., Wi-Fi). In various embodiments, network connection 103 includes an ad hoc network, an intranet, an extranet, a virtual private network (VPN), a local area network (LAN), a wireless LAN (WLAN), a wide area network (WAN), a portion of the Internet, a portion of the Public Switched Telephone Network (PSTN), a cellular telephone network, or any combination thereof. Network connection 103 may change form throughout environment 100. In addition, various user systems 104 (e.g., 105, 106, 107, and 108) and E-greeting system with video riff 101 described herein may be implemented using the example computer system illustrated in FIG. 6.

A platform to create video riffs, and to distribute corresponding media files, can be hosted by system 101, which may be accessed by a user using any user system 104 (e.g., 105, 106, 107, and 108). A user may be an individual or an entity. In one embodiment, two types of accounts are created: business accounts and individual accounts. A user may have an account associated with system 101, wherein the account may contain a variety of information associated with the user (e.g., the user's personal information, including the user's preferred name, username, preferences, E-greeting history, media files owned by the user, and so on). The user further has a profile associated with the account. A user may have a set of friends on system 101, and as such, the user's account may be associated with a list of friends. A user may share a media file or an E-greeting with a friend through the system 101. In various embodiments, the user adds friends from other social media platforms.

In various embodiments, a user may access, create, or share an e-card with a video riff via user system 104. In further embodiments, a user may upload, create, and distribute a digital media via user system 104. User system 104 can display any interface related to system 101. For example, user system 104 may be configured to receive an E-greeting customization input from a user, to transmit the E-greeting customization input to system 101, and to receive E-greeting instructions from system 101.

A user, in one embodiment, downloads a client component of an E-greeting, such as an E-greeting card application or a digital media distribution application. The client component may be executed locally at user system 104, whereas system 101 may provide back-end support for the client component and may be responsible for maintaining the E-greeting application data, processing inputs from users, updating and synchronizing displays among various users, distributing digital media, creating customized digital media, and transmitting instructions to various user systems such as user system 104.

The present disclosure, in accordance with one or more various embodiments, is described in detail with reference to the following figures. The figures, or drawings, are provided for purposes of illustration only and merely depict example embodiments of the disclosure. These drawings are provided to facilitate the reader's understanding of the disclosure, and shall not be considered limiting of the breadth, scope, or applicability of the disclosure or the claims.

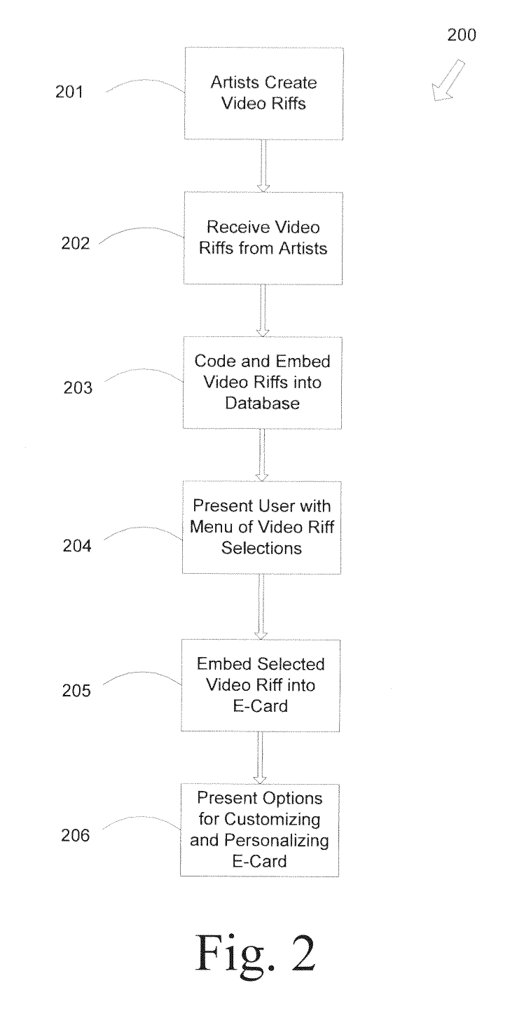

FIG. 2 is a flow diagram illustrating an example of a method for creating a riff gift according to an embodiment of the disclosure. Operation 201 involves one or more artists creating video riffs. These video riffs can be filmed or otherwise recorded. A video riff may comprise a 30-second or one-minute riff that is sung, played, spoken, rapped, or free-formed by a music or film star. By way of example, a video riff can be filmed or recorded using a mobile device or any other video recording system.

After creating the video riff, the artist uploads the riff to an online website or riff gift online site. At operation 202, the video riff system (such as system 101, 400, 410) receives the various video riffs uploaded by the participating artists. At operation 203, riff gift proprietary software codes and embeds the video riff into a database containing a menu of artists. This database can be searchable by the name of a desired artist. In addition, the database can be searchable within a number of categories, such as Occasions, Holidays, Expressions, Sports, and other categories.

With further reference to FIG. 2, upon a user accessing the riff gift page of the riff gift online site, operation 204 involves presenting the user with a menu of video riffs for selection of a particular riff to be embedded in the E-Card. This may entail presenting the user with a list of Occasions, Holidays, Expressions, Sports, and/or other categories, from which to select a video riff. For example, the user can search for a video riff pertaining to a selected Occasion, such as an anniversary or birthday. In one embodiment, the Occasions include Anniversary, Baby, Children, Faith, Get Well, In Memory Of, Mother/Father's Day, Thank You, Valentine, and Wedding.

The user can also search for a video riff pertaining to a particular Holiday, such as Christmas, Easter, Halloween, Hanukah, Faith, New Years, Passover, Thanksgiving, or other Holiday. Selectable Expressions can include Chill, Encourage, Fearless, Forgiveness, I'm Sorry, Let's Make Up, Love U, Prayer 4 You, Rock Me, Romance, and others. In further embodiments, the database of video riffs is also searchable within a Sports Category. Selectable Sports may include Baseball, Basketball, Football, Olympics, Skateboarding, Surf, and other sports.

In some embodiments, operation 204 entails presenting the user with a list of artists for the user to select a particular artist, and then presenting one or more video riffs by that artist for sampling and selection by the user. One or more mobile video riffs may be available for each artist, such that the user can choose a particular video riff to fit a desired occasion or expression. Operation 204 can further entail presenting the user with the option of narrowing down the menu of video riffs by selecting a particular Occasion for the riff gift (e.g., Birthday), or a selected Expression or Holiday for the riff gift. In this manner, the user can select an appropriate riff gift by a selected artist. The user, in some embodiments, may click on the icon of an artist to link to the artist's page.

At operation 205, the user-selected video is embedded into an E-card. Operation 206 entails presenting the user with options for customizing and personalizing the E-card. By way of example, the user can add a personal message to be displayed within the E-Card, can embed one or more custom pictures in the E-card, and can replace a standard background with a custom background. The riff gift E-card may now be sent to the recipient, e.g., via email.

Once the recipient receives the riff gift E-card, the recipient can be prompted to send a riff gift back to the original sender (i.e., the user). The user may be charged a predetermined price for purchasing the customized e-card with riff gift. In some embodiments, the artist or star shares in the net revenue from each e-card with riff video download. In further embodiments, users are given the option to purchase additional gifts, such as E-cards containing value-based items such as coupons, etc.

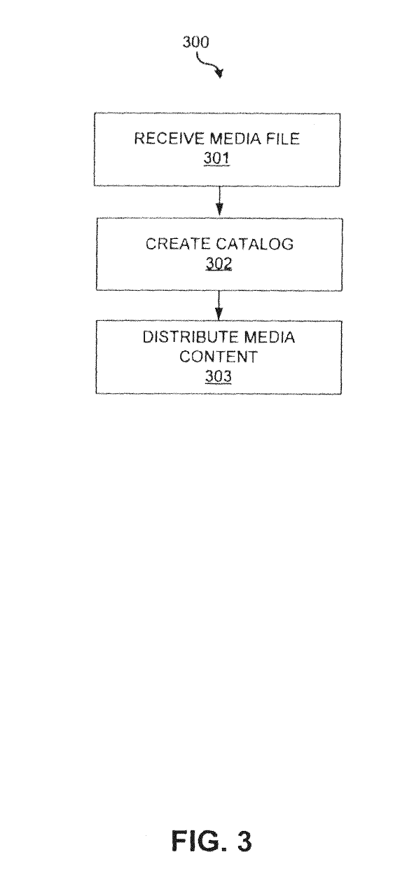

FIG. 3 is a flow chart illustrating an example method 300 for creating and distributing customized digital media in accordance with an embodiment of the methods and systems described herein. At operation 301, the method receives a media file from a user (e.g., a songwriter, recording artist). In various embodiments, a user having a business account on system 101 may be eligible to submit media files for distribution. A user with a business account may be an artist who creates a video riff. A business account may include additional sub-types, and each sub-type may be related to a royalty payment program. The method provides the user with options to create media content in connection with the media file that may be distributed. In one embodiment, the method provides the user with options to create a video riff for use in an E-greeting.

At operation 302, the method creates a catalog for each type of media content included in the media file. A catalog facilitates distribution of the media content. For example, a catalog may include the media file of a video riff, metadata of the video riff (e.g., author, album, song genre, description, lyrics), video riff characteristics information (e.g., suitable occasion, expression, etc.), and a royalty table. The royalty table provides for the calculation of royalty. In one embodiment, the method provides a platform where various users may collaborate in creating the catalog. At operation 303, the method distributes the media content according to the catalog and pays royalty accordingly. In some embodiments, the method publishes the media content and the catalog. The method, in further embodiments, distributes the royalty by sending a payment to appropriate accounts.

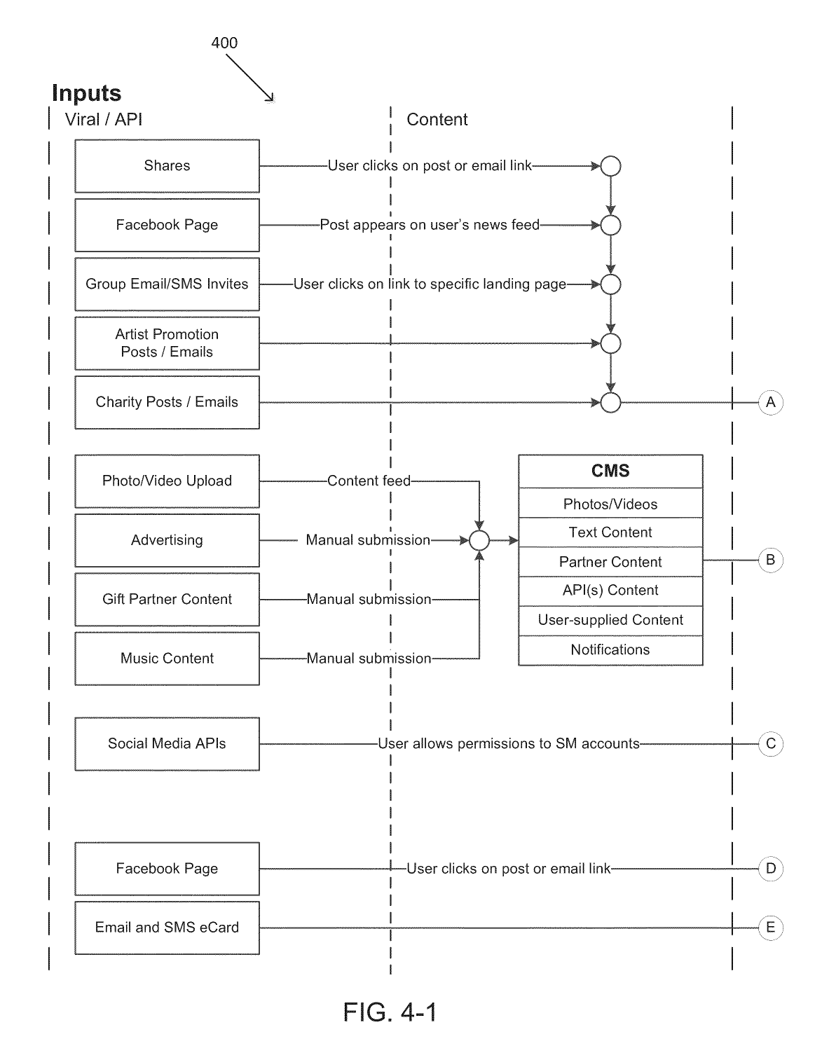

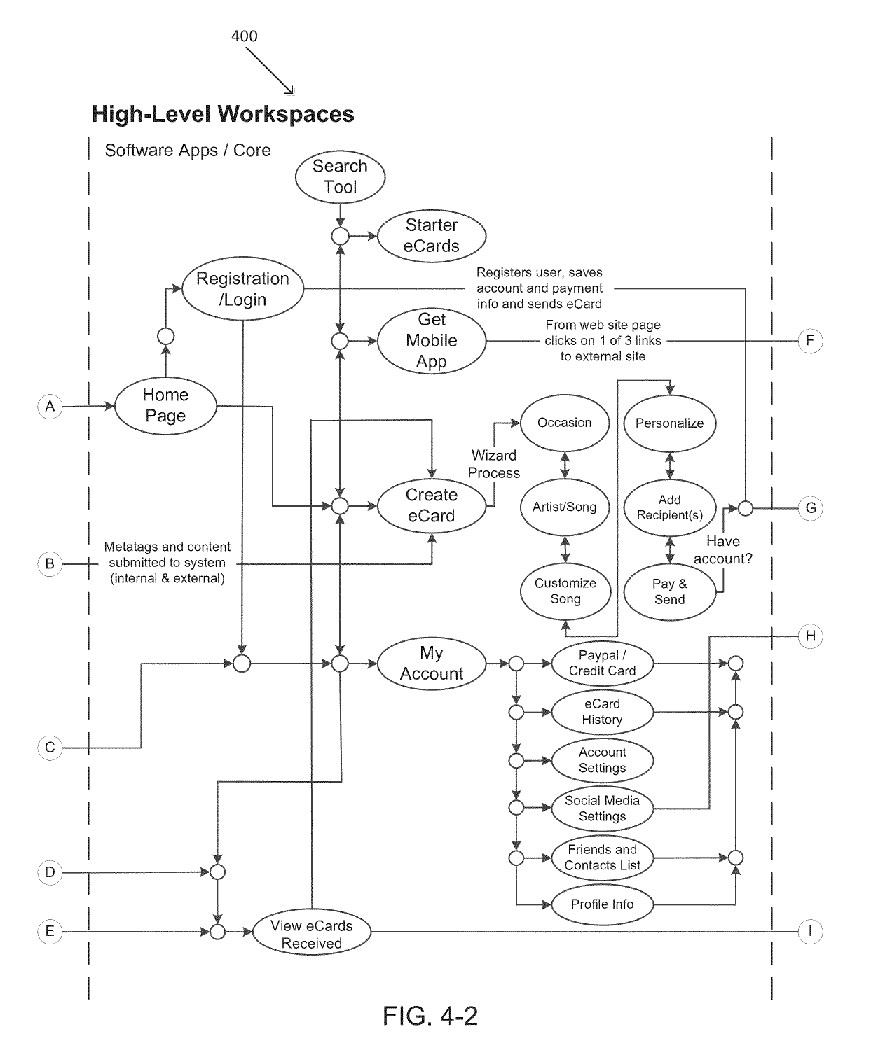

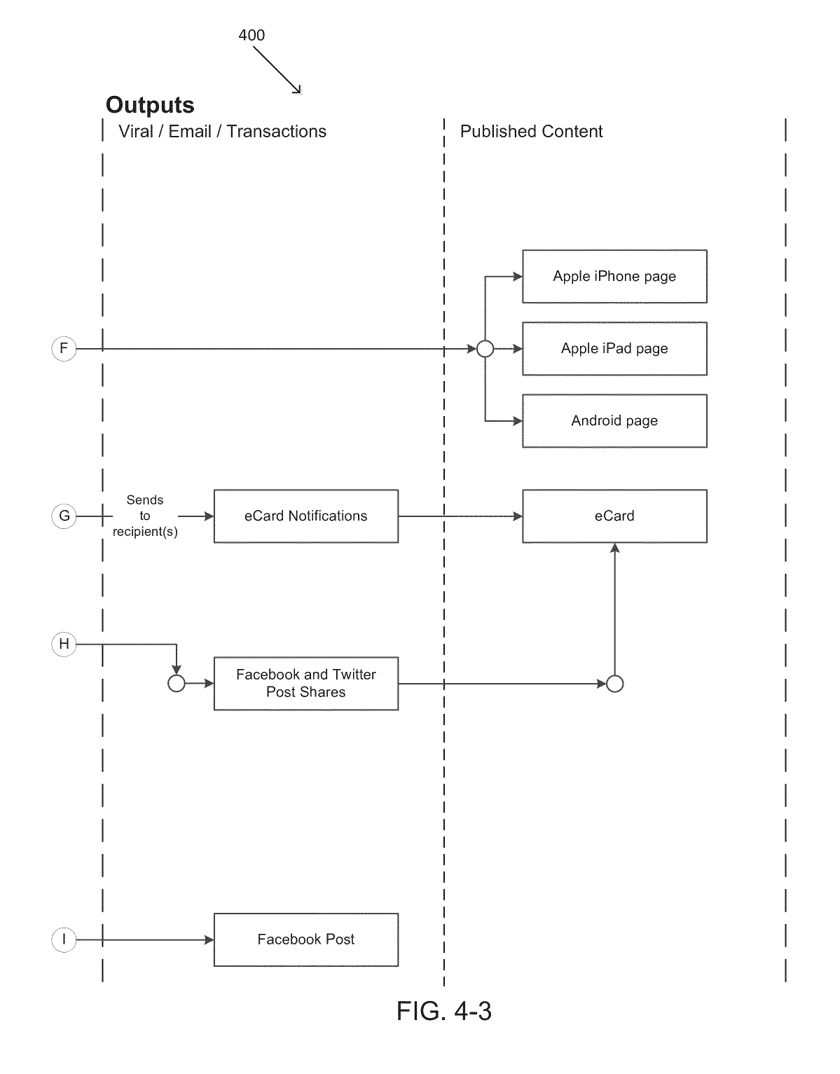

FIGS. 4-1 to 4-3, though separate sheets, should be read as a single figure spanning multiple pages. FIGS. 4-1 to 4-3 illustrate a system chart depicting example system 400 for creating a riff gift in accordance with an embodiment of the methods and systems described herein. In the illustrated example, system 400 includes an application programming interface (API) that provides a user access to the system. The user may be an individual or an entity. The example interface also provides advertising and gift partner content. In the illustrated example, system 400 includes a content management system where all the input from the API is processed. In the illustrated example, the system 400 includes software applications that: (i) host the system; (ii) process registration and log in, search, creation of E-greetings; and (iii) support various mobile applications and maintenance of accounts. Further, system 400 includes an output where the E-greetings are distributed.

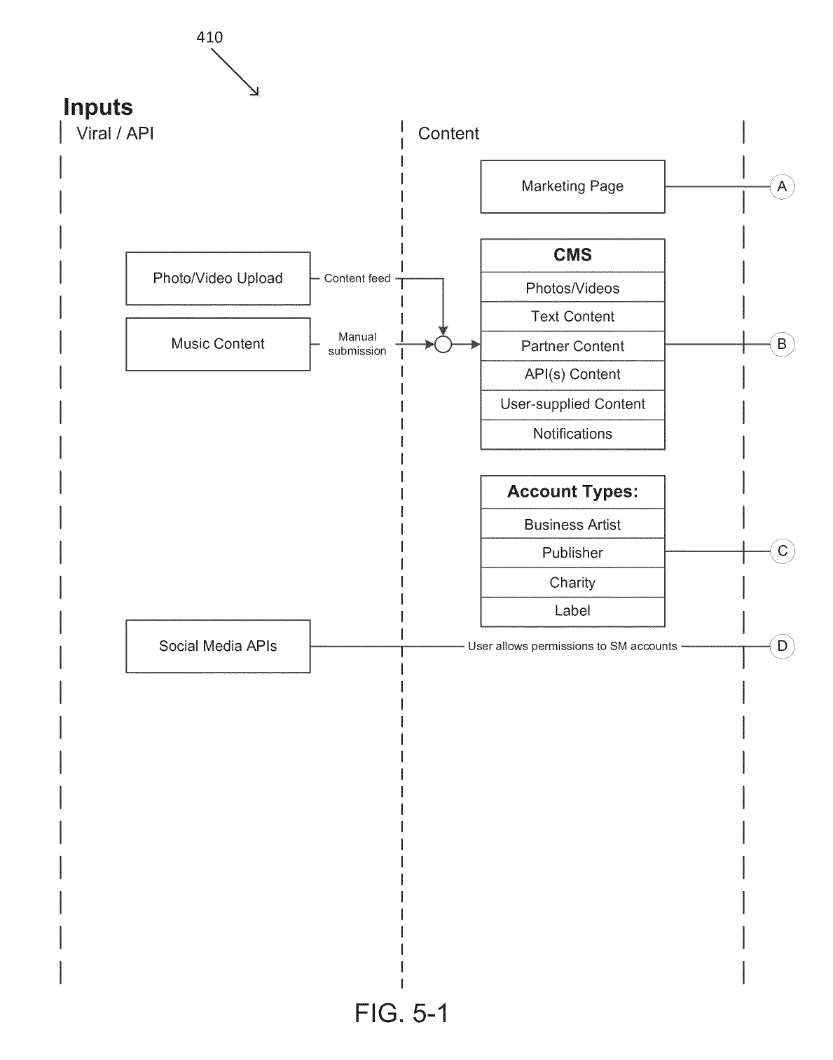

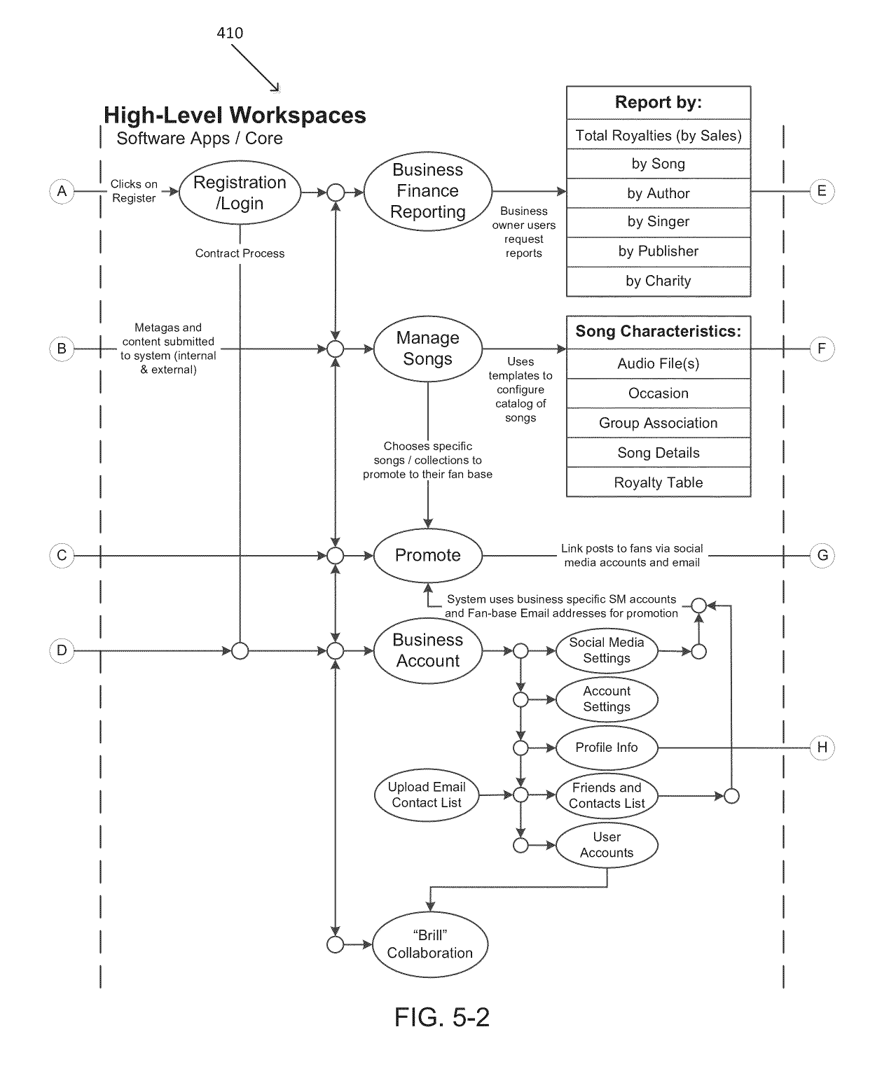

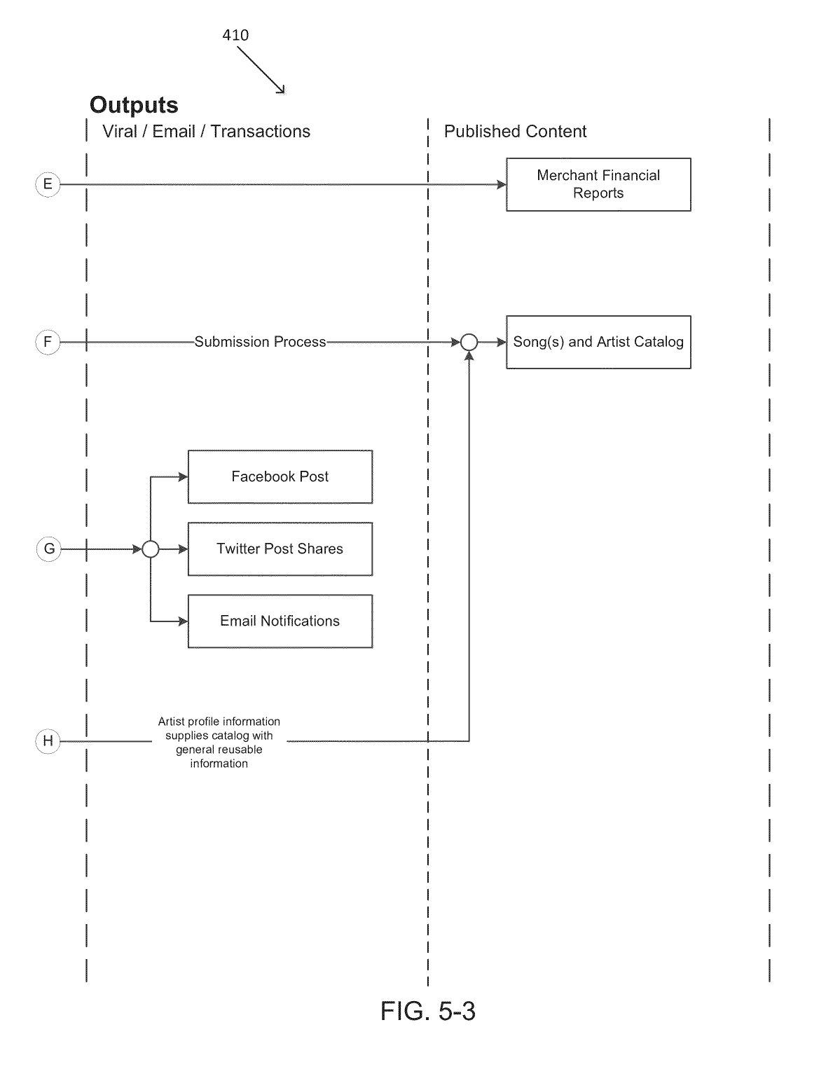

FIGS. 5-1 to 5-3, though separate sheets, should be read as a single figure spanning multiple pages. FIGS. 5-1 to 5-3 illustrate a system chart depicting example system 410 for creating a riff gift in accordance with an embodiment of the disclosure. In particular, system 410 includes an API whereby a user (e.g., an individual or an entity) may access system 410. In the illustrated example, system 410 includes a content management system where input from the API is processed. Additionally, system 400 includes software applications that: (i) host the E-greeting with riff gift system; (ii) process registration and log in; and (iii) promote digital media and process business finance reports. Further, system 410 includes an output where the riff gifts are distributed.

As used herein, the term set may refer to any collection of elements, whether finite or infinite. The term subset may refer to any collection of elements, wherein the elements are taken from a parent set; a subset may be the entire parent set. As used herein, the term module may describe a given unit of functionality that can be performed in accordance with one or more embodiments of the present disclosure. As used herein, a module may be implemented utilizing any form of hardware, software, or a combination thereof. For example, one or more processors, controllers, ASICs, PLAs, PALs, CPLDs, FPGAs, logical components, software routines or other mechanisms may be implemented to make up a module. In implementation, the various modules described herein may be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the disclosure are implemented in whole or in part using software, in one embodiment, these software elements can be implemented to operate with a computing or processing module capable of carrying out the functionality described with respect thereto. One such example computing module is shown in FIG. 6. Various embodiments are described in terms of this example-computing module 500. After reading this description, it will become apparent to a person skilled in the relevant art how to implement the disclosure using other computing modules or architectures.

Referring now to FIG. 6, computing module 600 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 600 may also represent computing capabilities embedded within or otherwise available to a given device. For example, a computing module may be found in other electronic devices such as, for example, digital cameras, navigation systems, cellular telephones, portable computing devices, modems, routers, WAPs, terminals and other electronic devices that may include some form of processing capability.

Computing module 600 may include, for example, one or more processors, controllers, control modules, or other processing devices, such as a processor 604. Processor 604 may be implemented using a general-purpose or special-purpose processing engine such as, for example, a microprocessor, controller, or other control logic. In the illustrated example, processor 604 is connected to a bus 602, although any communication medium can be used to facilitate interaction with other components of computing module 600 or to communicate externally.

Computing module 600 may also include one or more memory modules, simply referred to herein as main memory 608. For example, preferably random access memory (RAM) or other dynamic memory, may be used for storing information and instructions to be executed by processor 604. Main memory 608 may also be used for storing temporary variables or other intermediate information during execution of instructions to be executed by processor 604. Computing module 600 may likewise include a read only memory (“ROM”) or other static storage device coupled to bus 602 for storing static information and instructions for processor 604.

Computing module 600 may also include one or more various forms of information storage mechanism 610, which may include, for example, a media drive 612 and a storage unit interface 620. The media drive 612 may include a drive or other mechanism to support fixed or removable storage media 614. For example, a hard disk drive, a floppy disk drive, a magnetic tape drive, an optical disk drive, a CD or DVD drive (R or RW), or other removable or fixed media drive may be provided. Accordingly, storage media 614 may include, for example, a hard disk, a floppy disk, magnetic tape, cartridge, optical disk, a CD or DVD, or other fixed or removable medium that is read by, written to or accessed by media drive 612. As these examples illustrate, the storage media 614 can include a computer usable storage medium having stored therein computer software or data.

In further embodiments, information storage mechanism 610 may include other similar instrumentalities for allowing computer programs or other instructions or data to be loaded into computing module 600. Such instrumentalities may include, for example, a fixed or removable storage unit 622 and an interface 620. Examples of such storage units 622 and interfaces 620 can include a program cartridge and cartridge interface, a removable memory (for example, a flash memory or other removable memory module) and memory slot, a PCMCIA slot and card, and other fixed or removable storage units 622 and interfaces 620 that allow software and data to be transferred from the storage unit 622 to computing module 600.

Computing module 600 may also include a communications interface 624. Communications interface 624 may be used to allow software and data to be transferred between computing module 600 and external devices. Examples of communications interface 624 may include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 624 may be carried on signals, which can be electronic, electromagnetic (which includes optical) or other signals capable of being exchanged by a given communications interface 624. These signals may be provided to communications interface 624 via a channel 628. This channel 628 may carry signals and may be implemented using a wired or wireless communication medium. Some examples of a channel may include a phone line, a cellular link, an RF link, an optical link, a network interface, a local or wide area network, and other wired or wireless communications channels.

In this document, the terms “computer program medium,” “computer readable medium,” and “computer usable medium” are used to generally refer to media such as, for example, memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions may enable the computing module 600 to perform features or functions of the present disclosure as discussed herein.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the operations are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A non-transitory computer readable medium having computer executable program code embodied thereon, the computer executable program code configured to cause a computing device to create a riff gift for a recipient by:
receiving a set of video riffs from a set of artists;
coding and embedding the video riffs into a database;
presenting a video riff menu, comprising the set video riffs, from which a user chooses a selected video riff; and
embedding the selected video riff into an e-card such that the e-card is ready to be sent to the recipient.

2. The computer readable medium of claim 1, wherein one or more of the video riffs are sung, played, spoken, rapped, or free-formed by the artists.

3. The computer readable medium of claim 1, wherein the video riffs range from about 30 seconds to about 60 seconds long.

4. The computer readable medium of claim 1, wherein one or more of the video riffs are recorded using a mobile device or other video recording system.

5. The computer readable medium of claim 1, wherein the database is searchable based on at least one of the name of the artist, a selected occasion, a selected expression, and a selected holiday.

6. The computer readable medium of claim 1, wherein presenting the user with the video riff menu comprises:
presenting the user with a list of artists, from which the user selects a particular artist; and
presenting one or more video riffs by the particular artist for sampling and selection by the user.

7. The computer readable medium of claim 1, wherein the computer executable program code is further configured to share the e-card.

8. The computer readable medium of claim 7, wherein the e-card is shared via social media.

9. The computer readable medium of claim 1, wherein the computer executable program code is further configured to provide a platform to create video riffs.

10. The computer readable medium of claim 9, wherein the computer executable program code is further configured to create a user account associated with the user, wherein a user profile is associated with the user account, and wherein the user account is associated with a list of the user's friends.

11. A method for creating a riff gift for a recipient, the method comprising:
receiving a video riff from an artist;
coding and embedding the video riff into a database;
choosing a selected video riff; and
embedding the selected video riff into an e-card such that the e-card is ready to be sent to the recipient.

12. The method of claim 11, further comprising storing the e-card so that the e-card can subsequently be refreshed or recalled.

13. The method of claim 11, further comprising providing the user with additional options for gifts to accompany the e-card sent, the additional options comprising a retail items.

14. The method of claim 11, further comprising presenting an artist menu, comprising a set of video riffs performed by a particular artist, wherein choosing the selected video riff is done by the user via the artist menu.

15. The method of claim 11, further comprising presenting a video riff menu, the video riff menu comprising a set of received video riffs, wherein choosing the selected video riff is done by the user via the video riff menu.

16. The method of claim 11, further comprising creating a business account, through which media files are submitted for distribution.

17. A method for creating and distributing customized digital media, the method comprising:
receiving a media file from a user, the media file comprising media content;
creating a catalog for each type of media content in the media file;
distributing the media content according to the catalog; and
paying a royalty to the user based on the media content and the catalog.

18. The method of claim 17, wherein the catalog comprises a royalty table, and wherein the royalty table comprises information provided for calculating the royalty.

19. The method of claim 17, wherein the catalog comprises metadata associated with the video riff.

20. The method of claim 17, further comprising publishing the media content and the catalog.
